(19) United States
(12) Patent Application Publication
(10) Pub. No.: US 2021/0035533 A1
(43) Pub. Date: Feb. 4, 2021

(54) DISPLAY DEVICE AND DISPLAY METHOD

(71) Applicant: SEIKO EPSON CORPORATION, Tokyo (JP)

(72) Inventors: Hideki TANAKA, Chino-shi (JP); Yuya MARUYAMA, Fuefuki-shi (JP)

(73) Assignee: SEIKO EPSON CORPORATION, Tokyo (JP)

(21) Appl. No.: 16/941,926

(22) Filed: Jul. 29, 2020

(30) Foreign Application Priority Data
Jul. 30, 2019 (JP) 2019-139693

(51) Int. Cl. G09G 5/37; G06F 3/01; G06T 7/70; G06T 7/13; G06T 7/194; G09G 5/38; G06T 5/00; G02B 27/01

(52) U.S. Cl. CPC G09G 5/37; G06F 3/013; G06T 7/70; G06T 7/13; G06T 7/194; G02B 2027/014; G06T 5/002; G02B 27/0172; G09G 2340/12; G09G 2320/0686; G02B 2027/0138; G09G 5/38

(57) ABSTRACT

A preregistered target object is specified together with a position in a visual field of a user. Display of a form in which the visibility of a background of the target object is reduced relatively to the specified target object is performed as display in a display region. Specifically, the visibility of a part other than the target object desired to be visually recognized is relatively reduced and the part is displayed on an image display section.

The present application is based on, and claims priority from JP Application Serial Number 2019-139693, filed Jul. 30, 2019, the disclosure of which is hereby incorporated by reference herein in its entirety.

### BACKGROUND

### 1. Technical Field

The present disclosure relates to a technique for displaying a target in a visual field to be easily visually recognized.

### 2. Related Art

In recent years, as display devices such as an HMD, various display devices that display a virtual image in a visual field of a user have been proposed. In such display devices, a virtual image is linked with an actually present object in advance and, when the user views the object, for example, through the HMD, an image prepared in advance is displayed on a part or the entire object or displayed near the object.

For example, a display device described in JP-A-2014-93050 (Patent Literature 1) can display information necessary for a user, for example, image, with a camera, a sheet on which a character string is described, recognize the character string, and display, near the character string on the sheet, a translation and an explanation, an answer to a question sentence, or the like. Patent Literature 1 also discloses that, when presenting such information, the display device detects a visual line of the user, displays necessary information in a region gazed by the user, and blurs and displays an image of a region around the region. There has been also proposed a display device that, when displaying a video, detects a visual line position of a user and displays, as a blurred video, the periphery of a person gazed by the user (see, for example, JP-A-2017-21667 (Patent Literature 2)).

However, in the technique described in Patent Literature 1, the display device only detects the visual line of the user, displays information in the region gazed by the user, and blurs the region not gazed by the user. By nature, a human center visual field is as narrow as approximately several degrees in terms of an angle of view and a visual field other than the center visual field is not always clearly seen. Accordingly, even if an object that the user is about to view or an object or information about to be presented to the user is displayed in the visual field, for example, the object or the information could be overlooked if the object or the information deviates from the gazed region. Such a problem is not solved by the methods described in Patent Literatures 1 and 2.

### SUMMARY

The present disclosure can be realized as the following aspect or application example. That is, a display device includes a display region that allows a scene to be perceived by a user through the display region. The display device further includes one or more processors programmed, or configured, to specify a preregistered target object together with a position of the target object, and perform, as display in the display region, display of a form in which visibility of a background of the target object is reduced relatively to the specified target object.

### BRIEF DESCRIPTION OF THE DRAWINGS

FIG. 1 is an explanatory diagram illustrating an exterior configuration of an HMD in a first embodiment.

FIG. 2 is a main part plan view illustrating the configuration of an optical system included in an image display section.

FIG. 3 is an explanatory diagram illustrating amain part configuration of the image display section viewed from a user.

FIG. 4 is a flowchart illustrating an overview of display processing in the first embodiment.

FIG. 5 is an explanatory diagram illustrating an example of an outside scene viewed by the user wearing the HMD.

FIG. 6 is an explanatory diagram illustrating a state in which a contour of a target object is extracted.

FIG. 7 is an explanatory diagram illustrating an example of display in which visibility of parts other than a target desired to be visually recognized is reduced.

FIG. 8 is an explanatory diagram illustrating an example in which a target less easily visually recognized is displayed to be easily visually recognized.

FIG. 9 is an explanatory diagram illustrating a display example in which a large number of commodities are displayed in a vending machine.

FIG. 10 is a flowchart illustrating an overview of processing for changing easiness of visual recognition in a second embodiment.

FIG. 11 is an explanatory diagram illustrating an image captured when a vehicle is traveling in front of a building.

FIG. 12 is an explanatory diagram illustrating a display example in which a target image is emphasized.

FIG. 13 is an explanatory diagram illustrating a display example in which a background other than a target is painted out.

FIG. 14 is an explanatory diagram illustrating a display example in which the visibility of a periphery excluding a part of a specified object is reduced.

### DESCRIPTION OF EXEMPLARY EMBODIMENTS

### A. First Embodiment

### A-1. Overall Configuration of an HMD

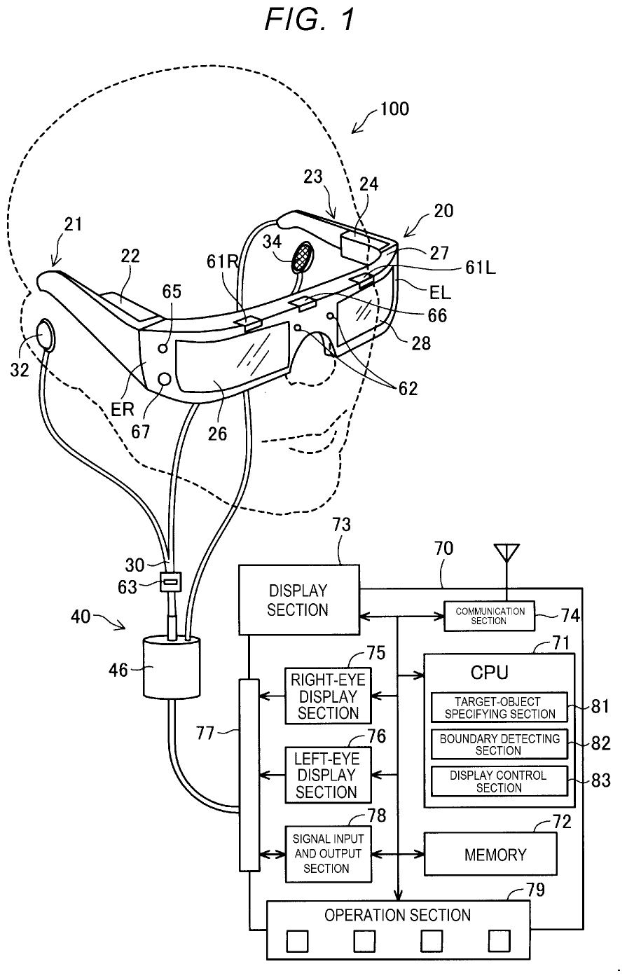

FIG. 1 is a diagram illustrating an exterior configuration of an HMD (Head Mounted Display) 100 in a first embodiment of the present disclosure. The HMD 100 is a display device including an image display section 20 (a display section) that causes a user to visually recognize a virtual image in a state in which the HMD 100 is mounted on the user's head and a control device 70 (a control section) that controls the image display section 20. The control device 70 exchanges signals with the image display section 20 and performs control necessary for causing the image display section 20 to display an image.

The image display section 20 is a wearing body worn on the user's head. In this embodiment, the image display section 20 has an eyeglass shape. The image display section 20 includes a right display unit 22, a left display unit 24, a right light guide plate 26, and a left light guide plate 28 in a main body including a right holding section 21, a left holding section 23, and a front frame 27.

The right holding section 21 and the left holding section 23 respectively extend backward from both end portions of the front frame 27 and, like temples of eyeglasses, hold the image display section 20 on the user's head. Of both the end portions of the front frame 27, an end portion located on the right side of the user in a worn state of the image display section 20 is represented as an end portion ER and an end portion located on the left side of the user in the worn state of the image display section 20 is represented as an end portion EL. The right holding section 21 is provided to extend from the end portion ER of the front frame 27 to a position corresponding to the right temporal region of the user in the worn state of the image display section 20. The left holding section 23 is provided to extend from the end portion EL of the front frame 27 to a position corresponding to the left temporal region of the user in the worn state of the image display section 20.

The right light guide plate 26 and the left light guide plate 28 are provided in the front frame 27. The right light guide plate 26 is located in front of the right eye of the user in the worn state of the image display section 20 and causes the right eye to visually recognize an image. The left light guide plate 28 is located in front of the left eye of the user in the worn state of the image display section 20 and causes the left eye to visually recognize an image.

The front frame 27 has a shape obtained by coupling one end of the right light guide plate 26 and one end of the left light guide plate 28 each other. A position of the coupling corresponds to the position of the middle of the forehead of the user in the worn state of the image display section 20. In the front frame 27, a nose pad section in contact with the nose of the user in the worn state of the image display section 20 may be provided in the coupling position of the right light guide plate 26 and the left light guide plate 28. In this case, the image display section 20 can be held on the user's head by the nose pad section, the right holding section 21, and the left holding section 23. A belt in contact with the back of the user's head in the worn state of the image display section 20 may be coupled to the right holding section 21 and the left holding section 23. In this case, the image display section 20 can be firmly held on the user's head by the belt.

The right display unit 22 performs display of an image by the right light guide plate 26. The right display unit 22 is provided in the right holding section 21 and is located near the right temporal region of the user in the worn state of the image display section 20. The left display unit 24 performs display of an image by the left light guide plate 28. The left display unit 24 is provided in the left holding section 23 and is located near the left temporal region of the user in the worn state of the image display section 20.

The right light guide plate 26 and the left light guide plate 28 in this embodiment are optical sections (for example, prisms or holograms) formed by light transmissive resin or the like and guide image lights output by the right display unit 22 and the left display unit 24 to the eyes of the user. Dimming plates may be provided on the surfaces of the right light guide plate 26 and the left light guide plate 28. The dimming plates are thin plate-like optical elements having different transmittances depending on light wavelength regions and function as so-called wavelength filters. For example, the dimming plates are disposed to cover the surface (the surface on the opposite side of the surface opposed to the eyes of the user) of the front frame 27. It is possible to adjust the transmittance of light in any wavelength region such as visible light, infrared light, and ultraviolet light by selecting an optical characteristic of the dimming plates as appropriate. It is possible to adjust a light amount of external light made incident on the right light guide plate 26 and the left light guide plate 28 from the outside and transmitted through the right light guide plate 26 and the left light guide plate 28.

The image display section 20 guides image lights respectively generated by the right display unit 22 and the left display unit 24 to the right light guide plate 26 and the left light guide plate 28 and causes the user to visually recognize a virtual image with the image lights (this is referred to as “display an image” as well). When the external light is transmitted optically through the right light guide plate 26 and the left light guide plate 28 from the front of the user and made incident on the eyes of the user, the image lights forming the virtual image and the external light are made incident on the eyes of the user. Accordingly, the visibility of the virtual image in the user is affected by the intensity of the external light.

Accordingly, it is possible to adjust easiness of visual recognition of the virtual image by, for example, mounting the dimming plates on the front frame 27 and selecting or adjusting the optical characteristic of the dimming plates as appropriate. In a typical example, a dimming plate having light transmissivity of a degree for enabling the user wearing the HMD 100 to visually recognize at least an outside scene can be selected. When the dimming plates are used, it is possible to expect an effect of protecting the right light guide plate 26 and the left light guide plate 28 and suppressing damage, adhesion of soil, and the like to the right light guide plate 26 and the left light guide plate 28. The dimming plates may be detachably attachable to the front frame 27 or each of the right light guide plate 26 and the left light guide plate 28. A plurality of types of dimming plates may be replaced to be attachable and detachable. The dimming plates may be omitted.

Besides the members relating to the image display explained above, two cameras 61R and 61L, an inner camera 62, an illuminance sensor 65, a six-axis sensor 66, and an LED indicator 67 are provided in the image display section 20. The two cameras 61R and 61L are disposed on the upper side of the front frame 27 of the image display section 20. The two cameras 61R and 61L are provided in positions substantially corresponding to both the eyes of the user and are capable of measuring a distance to a target object by so-called binocular vision. The measurement of the distance is performed by the control device 70. The cameras 61R and 61L may be provided in any positions if the cameras 61R and 61L can measure the distance by the binocular vision. The cameras 61R and 61L may be respectively disposed at the end portions ER and EL of the front frame 27. The measurement of the distance to the target object can also be realized by, for example, being performed by a monocular camera and an analysis of an image photographed by the monocular camera or being performed by a millimeter wave radar.

The cameras 61R and 61L are digital cameras including imaging elements such as CCDs or CMOSs and imaging lenses. The cameras 61R and 61L image at least a part of an outside scene (a real space) in the front side direction of the HMD 100, in other words, a visual field direction visually recognized by the user in the worn state of the image display section 20. In other words, the cameras 61R and 61L image a range or a direction overlapping the visual field of the user and image a direction visually recognized by the user. In this embodiment, the width of an angle of view of the cameras 61R and 61L is set to image the entire visual field of the user visually recognizable by the user through the right light guide plate 26 and the left light guide plate 28. An optical system capable of setting the width of the angle of view of the cameras 61R and 61L as appropriate may be provided.

Like the cameras 61R and 61L, the inner camera 62 is a digital camera including an imaging element such as a CCD or a CMOS and an imaging lens. The inner camera 62 images an inner direction of the HMD 100, in other words, a direction facing the user in the worn state of the image display section 20. The inner camera 62 in this embodiment includes an inner camera for imaging the right eye of the user and an inner camera for imaging the left eye of the user. In this embodiment, the width of an angle of view of the inner camera 62 is set in a range in which the inner camera 62 is capable of imaging the entire right eye or left eye of the user. The inner camera is used to detect the positions of the eyeballs, in particular, the pupils of the user and calculate a direction of a visual line of the user from the positions of the pupils of both the eyes. It goes without saying that an optical system capable of setting the width of the angle of view as appropriate may be provided in the inner camera 62. The inner camera 62 may be used to image not only the pupils of the user but also a wider region to read an expression and the like of the user.

The illuminance sensor 65 is provided at the end portion ER of the front frame 27 and disposed to receive external light from the front of the user wearing the image display section 20. The illuminance sensor 65 outputs a detection value corresponding to a light reception amount (light reception intensity). The LED indicator 67 is disposed at the end portion ER of the front frame 27. The LED indicator 67 is lit during execution of the imaging by the cameras 61R and 61L and informs that the imaging is being executed.

The six-axis sensor 66 is an acceleration sensor and detects movement amounts in X, Y, and Z directions (three axes) of the user's head and tilts (three axes) with respect to the X, Y, and Z directions of the user's head. Among the X, Y, and Z directions, the Z direction is a direction along the gravity direction, the X direction is a direction from the back to the front of the user, and the Y direction is a direction from the left to the right of the user. The tilts of the head are angles around axes (an X axis, a Y axis, and a Z axis) in the X, Y, and Z directions. It is possible to learn a movement amount and an angle of the user's head from an initial position by integrating signals from the six-axis sensor 66.

The image display section 20 is coupled to the control device 70 by a connection cable 40. The connection cable 40 is drawn out from the distal end of the left holding section 23 and detachably coupled to, via a relay connector 46, a connector 77 provided in the control device 70. The connection cable 40 includes a headset 30. The headset 30 includes a microphone 63 and a right earphone 32 and a left earphone 34 attached to the left and right ears of the user. The headset 30 is coupled to the relay connector 46 and integrated with the connection cable 40.

### A-2. Configuration of the Control Device

The control device 70 includes, as illustrated in FIG. 1, a right-eye display section 75, a left-eye display section 76, a signal input and output section 78, and an operation section 79 besides a CPU 71, a memory 72, a display section 73, and a communication section 74, which are well known. A predetermined OS is incorporated in the control device 70. The CPU 71 executes, under management by the OS, programs stored in the memory 72 to thereby realize various functions. In FIG. 1, examples of the realized functions are illustrated as a target-object specifying section 81, a boundary detecting section 82, a display control section 83, and the like in the CPU 71.

The display section 73 is a display provided in a housing of the control device 70 and displays various kinds of information concerning display on the image display section 20. Apart or all of these kinds of information can be changed by operation using the operation section 79. The communication section 74 is coupled to a communication station using a 4G or 5G communication network. Therefore, the CPU 71 is accessible to a network via the communication section 74 and is capable of acquiring information and images from Web sites on the network. When acquiring images, information, and the like through the Internet, the user can operate the operation section 79 and select files of moving images and images that the user causes the image display section 20 to display. The user can also select various settings concerning the image display section 20, for example, brightness of an image to be displayed and conditions for use of the HMD 100 such as an upper limit of a continuous use time. It goes without saying that the user can cause the image display section 20 itself to display such information. Therefore, such processing and setting are possible even if the display section 73 is absent.

The signal input and output section 78 is an interface circuit that exchanges signals from the other devices excluding the right display unit 22 and the left display unit 24, that is, the cameras 61R and 61L, the inner camera 62, the illuminance sensor 65, and the LED indicator 67 incorporated in the image display section 20. The CPU 71 can read, via the signal input and output section 78, captured images of the cameras 61R and 61L and the inner camera 62 of the image display section 20 from the cameras 61R and 61L and the inner camera 62 and light the LED indicator 67.

The right-eye display section 75 outputs, with the right display unit 22, via the right light guide plate 26, an image that the right-eye display section 75 causes the right eye of the user to visually recognize. Similarly, the left-eye display section 76 outputs, with the left display unit 24, via the left light guide plate 28, an image that the left-eye display section 76 causes the left eye of the user to visually recognize. The CPU 71 calculates a position of an image that the CPU 71 causes the user to recognize, calculates a parallax of the binocular vision such that a virtual image can be seen in the position, and outputs right and left images having the parallax to the right display unit 22 and the left display unit 24 via the right-eye display section 75 and the left-eye display section 76.

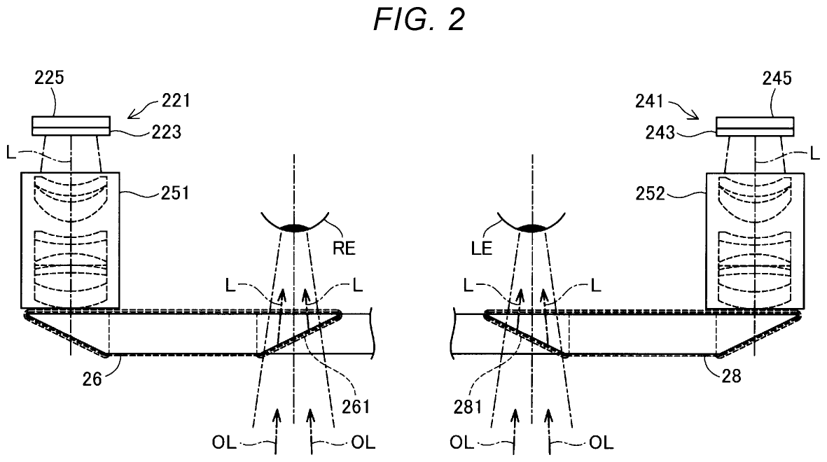

An optical configuration for causing the user to recognize an image using the right display unit 22 and the left display unit 24 is explained. FIG. 2 is a main part plan view illustrating the configuration of an optical system included in the image display section 20. For convenience of explanation, a right eye RE and a left eye LE of the user are illustrated in FIG. 2. As illustrated in FIG. 2, the right display unit 22 and the left display unit 24 are symmetrically configured.

As components for causing the right eye RE to visually recognize a virtual image, the right display unit 22 functioning as a right image display section includes an OLED (Organic Light Emitting Diode) unit 221 and a right optical system 251. The OLED unit 221 emits image light L. The right optical system 251 includes a lens group and guides the image light L emitted by the OLED unit 221 to the right light guide plate 26.

The OLED unit 221 includes an OLED panel 223 and an OLED driving circuit 225 configured to drive the OLED panel 223. The OLED panel 223 is a self-emission type display panel that emits light with organic electroluminescence and is configured by light emitting elements that respectively emit color lights of R (red), G (green), and B (blue). On the OLED panel 223, a plurality of pixels, a unit of which including one each of R, G, and B elements is one pixel, are arranged in a matrix shape.

The OLED driving circuit 225 executes selection and energization of the light emitting elements included in the OLED panel 223 according to a signal sent from the right-eye display section 75 of the control device 70 and causes the light emitting elements to emit light. The OLED driving circuit 225 is fixed to the rear surface of the OLED panel 223, that is, the rear side of a light emitting surface by bonding or the like. The OLED driving circuit 225 may be configured by, for example, a semiconductor device that drives the OLED panel 223 and mounted on a substrate fixed to the rear surface of the OLED panel 223. In the OLED panel 223, a configuration in which light emitting elements that emit light in white are arranged in a matrix shape and color filters corresponding to the colors of R, G, and B are superimposed and arranged may be adopted. The OLED panel 223 having a WRGB configuration including light emitting elements that emit white (W) light in addition to the light emitting elements that respectively emit the R, G, and B lights may be adopted.

The right optical system 251 includes a collimate lens that collimates the image light L emitted from the OLED panel 223 into light beams in a parallel state. The image light L collimated into the light beams in the parallel state by the collimate lens is made incident on the right light guide plate 26. A plurality of reflection surfaces that reflect the image light L are formed in an optical path for guiding light on the inside of the right light guide plate 26. The image light L is guided to the right eye RE side through a plurality of times of reflection on the inside of the right light guide plate 26. A half mirror 261 (a reflection surface) located in front of the right eye RE is formed on the right light guide plate 26. After being reflected on the half mirror 261, the image light L is emitted from the right light guide plate 26 to the right eye RE and forms an image on the retina of the right eye RE to cause the user to visually recognize a virtual image.

As components for causing the left eye LE to visually recognize a virtual image, the left display unit 24 functioning as a left image display section includes an OLED unit 241 and a left optical system 252. The OLED unit 241 emits the image light L. The left optical system 252 includes a lens group and guides the image light L emitted by the OLED unit 241 to the left light guide plate 28. The OLED unit 241 includes an OLED panel 243 and an OLED driving circuit 245 that drives the OLED panel 243. Details of the sections are the same as the details of the OLED unit 221, the OLED panel 223, and the OLED driving circuit 225. Details of the left optical system 252 is the same as the details of the right optical system 251.

With the configuration explained above, the HMD 100 can function as a see-through type display device. That is, the image light L reflected on the half mirror 261 and external light OL transmitted through the right light guide plate 26 are made incident on the right eye RE of the user. The image light L reflected on a half mirror 281 and the external light OL transmitted through the left light guide plate 28 are made incident on the left eye LE of the user. In this way, the HMD 100 superimposes the image light L of the image processed on the inside and the external light OL and makes the image light L and the external light OL incident on the eyes of the user. As a result, for the user, light from an outside scene (a real world) is allowed to be seen, or perceived, optically through the right light guide plate 26 and the left light guide plate 28 and the virtual image by the image light L is visually recognized as overlapping the outside scene. That is, the image display section 20 of the HMD 100 transmits the outside scene to cause the user to visually recognize the outside scene in addition to the virtual image.

The half mirror 261 and the half mirror 281 reflect the image lights L respectively output by the right display unit 22 and the left display unit 24 and extract images. The right optical system 251 and the right light guide plate 26 are collectively referred to as “right light guide section” as well. The left optical system 252 and the left light guide plate 28 are collectively referred to as “left light guide section” as well. The configuration of the right light guide section and the left light guide section is not limited to the example explained above. Any system can be used as long as the right light guide section and the left light guide section form a virtual image in front of the eyes of the user using the image lights. For example, in the right light guide section and the left light guide section, a diffraction grating may be used or a semi-transmissive reflection film may be used.

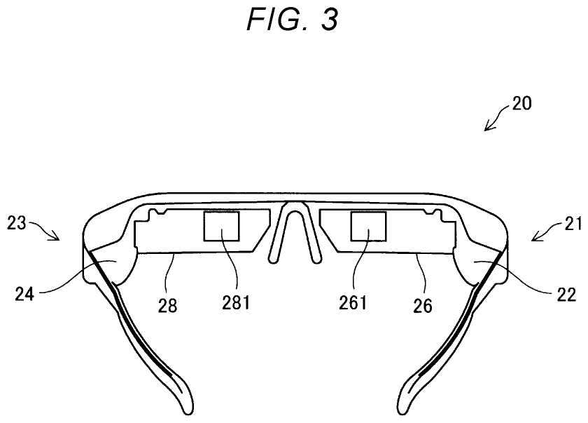

FIG. 3 is a diagram illustrating a main part configuration of the image display section 20 viewed from the user. In FIG. 3, illustration of the connection cable 40, the right earphone 32, and the left earphone 34 is omitted. In a state illustrated in FIG. 3, the rear sides of the right light guide plate 26 and the left light guide plate 28 can be visually recognized. The half mirror 261 for irradiating image light on the right eye RE and the half mirror 281 for irradiating image light on the left eye LE can be visually recognized as substantially square regions. The user visually recognizes an outside scene through the entire right and left light guide plates 26 and 28 including the half mirrors 261 and 281 and visually recognizes rectangular display images in the positions of the half mirrors 261 and 281.

The user wearing the HMD 100 having the hardware configuration explained above can visually recognize an outside scene through the right light guide plate 26 and the left light guide plate 28 of the image display section 20 and can further view images formed on the panels 223 and 243 as a virtual image via the half mirrors 261 and 281. That is, the user of the HMD 100 can superimpose and view the virtual image on a real outside scene. The virtual image may be an image created by computer graphics as explained below or may be an actually captured image such as an X-ray photograph or a photograph of a component. The “virtual image” is not an image of an object actually present in an outside scene and means an image displayed by the image display section 20 to be visually recognizable by the user.

### A-3. Image Display Processing

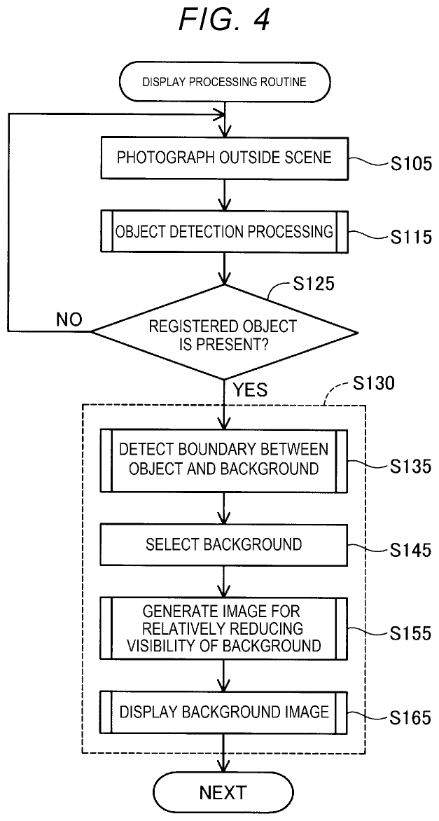

Processing for displaying such a virtual image and appearance in that case are explained below. FIG. 4 is a flowchart illustrating processing executed by the control device 70. The processing is repeatedly executed while a power supply of the HMD 100 is on.

When the processing illustrated in FIG. 4 is started, first, the control device 70 performs processing for photographing an outside scene with the cameras 61R and 61L (step S105). The control device 70 captures images photographed by the cameras 61R and 61L via the signal input and output section 78. The CPU 71 performs processing for analyzing the images and detecting objects (step S115). These kinds of processing may be performed using one of the cameras 61R and 61L, that is, using an image photographed by a monocular camera. If the images photographed by the two cameras 61R and 61L disposed a predetermine distance apart are used, stereoscopic vision is possible. Object detection can be accurately performed. The object detection is performed for all objects present in the outside scene. Therefore, if a plurality of objects are present in the outside scene, the plurality of objects are detected.

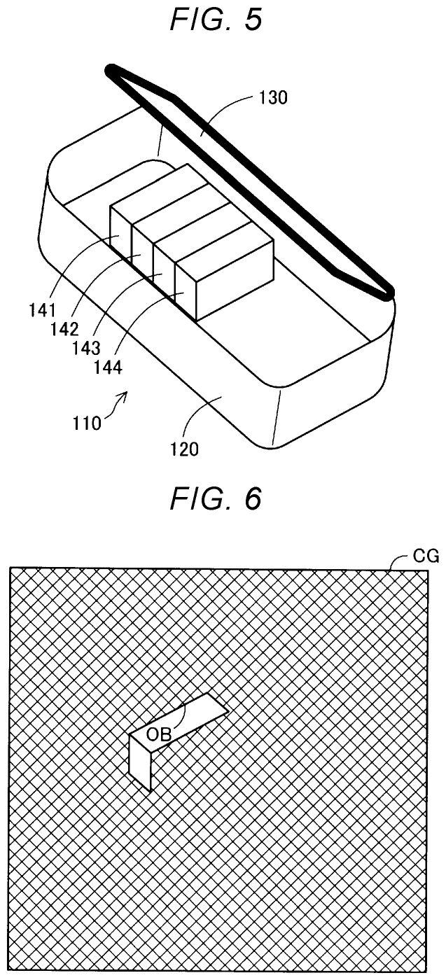

An example of an outside scene viewed by the user wearing the HMD 100 is illustrated in FIG. 5. In this example, the user wears the HMD 100 and is about to replace an ink cartridge of a specific color of a printer 110. In the printer 110, when a cover 130 is opened, four ink cartridges 141, 142, 143, and 144 replaceably arrayed in a housing 120 are seen. Illustration of the other structure of the printer 110 is omitted.

After performing the object detection processing (step S115), the CPU 71 determines whether a preregistered object is present among the detected objects (step S125). This processing is equivalent to processing for specifying a target object by the target-object specifying section 81 of the CPU 71. Presence of the preregistered object in the detected objects can be specified by matching with an image prepared for the preregistered object. Since a captured image of the object varies depending on an imaging direction and a distance, it is determined whether the captured image coincides with the image prepared in advance using a so-called dynamic matching technique. It goes without saying that, as illustrated in FIG. 5, when a specific product is treated as the registered object, a specific sign or character string may be printed or inscribed on the surface of the object. It may be specified that an object is the registered object by extracting the specific sign or character string. In the example illustrated in FIG. 5, if the preregistered object, for example, a cartridge, an ink color of which is “yellow”, is absent among the detected objects, the CPU 71 returns to step S105 and repeats the processing from the photographing by the cameras 61R and 61L. In this embodiment, it is assumed that, as an object, concerning the ink cartridges 141 to 144 mounted on the printer 110, the ink cartridge 142 storing ink of a specific color is registered in advance. When determining that the ink cartridge 142, which is the preregistered object, is present among the objects detected by the images photographed by the cameras 61R and 61L (“YES” in step S125), the CPU 71 executes visibility changing and displaying processing for changing and displaying relative visibility of a registered object and the periphery (step S130). This processing in step S130 is equivalent to processing by the display control section 83 of the CPU 71. This processing is explained in detail below.

When starting this processing, first, the CPU 71 performs processing for detecting a boundary between the registered object and the background (step S135). The detection of the boundary can be easily performed by extracting an edge present near the specified object. This processing is equivalent to processing by the boundary detecting section 82 of the CPU 71. When detecting the boundary between the specified object and the background in this way, the CPU 71 regards the outer side of the boundary as the background and selects the background (step S145). Selecting the background means selecting the entire outer side of the boundary of the detected object in the visual field of the user. A state of the selection of the background performed when the user is viewing the printer 110 illustrated in FIG. 5 using the HMD 100 and the specified object is the “yellow” ink cartridge 142 is illustrated in FIG. 6. The CPU 71 recognizes the boundary of the specified object as an edge OB of an image to select a region on the outer side of the boundary as the background (a region indicated by a sign CG).

Then, the CPU 71 performs processing for generating an image for relatively reducing the visibility of the background (step S155) and displays the image as a background image (step S165). After the processing explained above, the CPU 71 leaves the processing to “NEXT” and ends this routine once.

### A-4. Effects of the Embodiment

In the first embodiment, in step S155, the image illustrated in FIG. 6 is generated as the image for relatively reducing the visibility of the background. In the example illustrated in FIG. 6, computer graphics CG in which the entire outer side of the edge OB detected about the “yellow” ink cartridge 142 is set to gray with brightness of 50% is generated. The brightness of 50% specifically means an image formed by alternately setting pixels of the right and left OLED panels 223 and 243 of the HMD 100 to ON (white) and OFF (black) for each one dot. Since images formed on the OLED panels 223 and 243 are images of a light emission system, light is not emitted from OFF (black) dots. All light emitting elements of the three primary colors emit light from ON (white) dots so that white light is emitted. Lights from the OLED panels 223 and 243 are guided to the half mirrors 261 and 281 by the right and left light guide plates 26 and 28 and formed on the half mirrors 261 and 281 as an image visually recognized by the user. The image formed by alternately setting the pixels of the right and left OLED panels 223 and 243 of the HMD 100 to ON (white) and OFF (black) for each one dot is, in other words, an image in which the outside scene can be visually recognized in half dots (black) of the image and dots (white) are visually recognized on the outside scene in half dots.

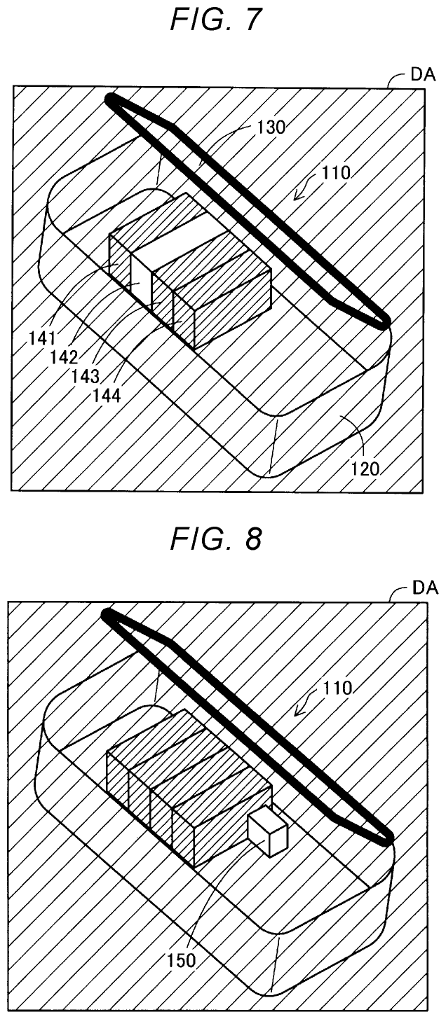

In the computer graphics CG illustrated in FIG. 6, dots on the inner side of the edge OB detected about the “yellow” ink cartridge 142 are set to OFF (black) and the entire outer side of the edge OB is set to gray with brightness of 50%. Therefore, the “yellow” ink cartridge 142 is directly caught by the eyes of the user and the other ink cartridges are caught by the eyes as an image having approximately half brightness. In the ink cartridges other than the “yellow” cartridge 142, every other white dots are caught by the eyes. Therefore, the ink cartridges are visually recognized by the user like a blurred image. This state is illustrated in FIG. 7. In the ink cartridges other than the “yellow” ink cartridge 142, the dots are alternately ON (white) dots. The outside scene is seen through the other dots. Therefore, a hue (a tint and brightness) and the like of objects in the outside scene, for example, the other ink cartridges 141, 143, and 144 is seen in a state in which an original hue is reasonably reflected.

Accordingly, for example, when ink of the “yellow” ink cartridge 142 is exhausted and the “yellow” ink cartridge 142 is replaced, the user wearing the HMD 100 can easily recognize which cartridge is the ink cartridge that should be replaced. That is, easiness of recognition is relatively differentiated between a target that the user should gaze and the periphery of the object. Therefore, the target that the user should gaze can be clarified rather than a target that the user is gazing. The user can be guided to recognize a specific cartridge. In other words, the visual line of the user can be guided to a desired member. The human visual field is approximately 130 degrees in the up-down direction and approximately 180 degrees in the left-right direction. However, the center visual field at the time when the user is viewing a target object is as narrow as approximately several degrees in terms of an angle of view. The visual field other than the center visual field is not always clearly seen. Accordingly, even if an object or information that the user is about to view is present in the visual field, the object or the information could be overlooked if the object or the information deviates from a region to which the user pays attention. In the HMD 100 in this embodiment, since objects other than the target that the user should gaze are blurred, the visual line of the user is naturally guided to the target that the user should gaze.

### A-5. Other Configuration Examples

Such guidance of the visual line of the user is particularly effective, for example, when a component or the like to be gazed is small or when the component or the like is present in a position easily hidden by other components. FIG. 8 is an explanatory diagram illustrating such a case. The user who opens the cover 130 of the printer 110 in order to replace an ink cartridge is sometimes distracted by the arranged four ink cartridges 141 to 144 and does not notice the presence of another small component 150 disposed beside the ink cartridges 141 to 144. In such a case, if the visibility of components other than the component 150 is relatively reduced, the user naturally gazes the component 150 even if the component 150 is small or present in a position less easily seen. As such a component, in a printer, various components such as an ink pump, an ink absorber case, and a motor for carrier conveyance are conceivable.

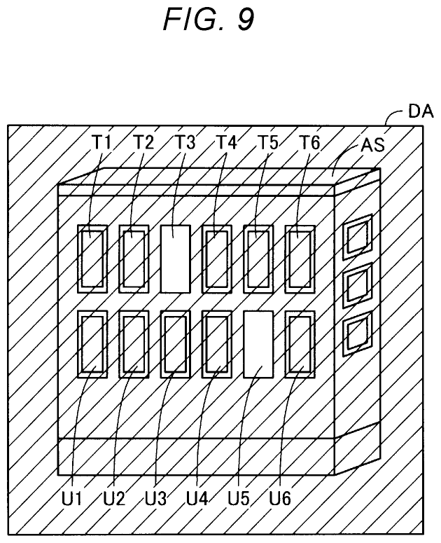

Such guidance of the visual line can also be used when a large number of similar components or commodities are present and the HMD 100 causes the user to recognize a desired target object among the components or the commodities. FIG. 9 is an explanatory diagram illustrating a case in which a large number of commodities are displayed in a vending machine AS. As illustrated in FIG. 9, commodities T1 to T6 are arranged in the upper level and commodities U1 to U6 are arranged in the lower level in the vending machine AS. In the case of drinking water in cans or PET bottles, in some case, the shapes of the commodities are substantially the same or the sizes of the commodities are different but the shapes of the commodities are similar. In such a case, it is assumed that the user operates the operation section 79 of the HMD 100 to input “I want to drink XX” and the control device 70 of the HMD 100 specifies that a commodity “XX” is sold in the vending machine AS near the user through communication. Further, it is assumed that the control device 70 specifies that the commodity “XX” is present as a third commodity T3 from the left in the upper level and a commodity similar to the commodity is displayed and sold as a fifth commodity U5 from the left in the lower level.

Then, the HMD 100 executes the processing illustrated in FIG. 4 and superimposes and displays, on the outside scene viewed by the user, the gray computer graphics CG excluding only the portions of the commodities T3 and U5. FIG. 9 is an explanatory diagram illustrating appearance of the vending machine AS viewed by the user when the computer graphics CG is superimposed on the vending machine AS. As illustrated in FIG. 9, in the vending machine AS, the target commodity T3 and the similar commodity U5 of the commodity T3 are displayed to be relatively easily seen compared with the periphery. Therefore, the user of the HMD 100 can immediately visually recognize the target commodity. In this example, a displayed commodity is a commodity retrieved by the user. However, a specific commodity, for example, drinking water or the like having a high effect of heat shock prevention may be displayed to be relatively easily seen compared with the periphery as a recommended commodity according to information such as temperature, humidity, and sunshine in the day. Alternatively, a sale target commodity or the like may be displayed to be relatively easily seen compared with the periphery. The number of components displayed to be easily seen may be one or may be three or more. When a large number of vending machines AS are arranged, a specific vending machine AS may be displayed to be relatively easily visually recognized than the other. It goes without saying that such display is not limited to the vending machine and can be applied to other various target objects and objects. For example, in the case of surgical operation, an affected part may be specified in advance using a device such as CT or MRI. A surgeon may wear the HMD 100 during operation to recognize an operation target organ and display parts other than the affected part in the organ with reduced visibility. In this way, it is possible to suppress a surgical part from being mistaken or suppress the surgeon from being distracted by other parts.

### B. Second Embodiment

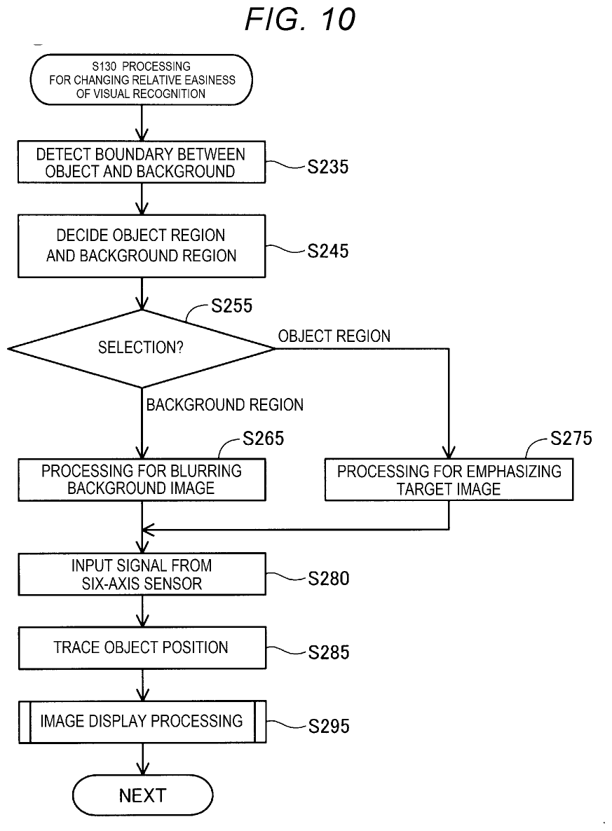

A second embodiment is explained. The HMD 100 in the second embodiment has the same hardware configuration as the hardware configuration in the first embodiment. As processing content of the control device 70, as in the processing content illustrated in FIG. 4, the processing for changing relative easiness of visual recognition (step S130) is performed but content of the processing is different. The processing is explained with reference to FIG. 10.

When performing the photographing of the outside scene (step S105 in FIG. 4) and the object detection processing (step S115 in FIG. 4) and determining that the registered object is present in the outside scene (“YES” in step S125), as illustrated in FIG. 10, the HMD 100 executes the processing for changing relative easiness of visual recognition of the registered object (step S130). In the processing, first, the HMD 100 performs processing for detecting a boundary between the object and the background of the object (step S235). It could occur that the boundary is not always a closed region. Therefore, in the following step S245, the HMD 100 decides an object region and a background region (step S245). The boundary is not the closed region, for example, when the object is present at an end of a visual field of the HMD 100 and a part of the object protrudes to the outside of the visual field or when a hue (a tint and brightness) of a part of the object is similar to a hue of the background and a portion that cannot be recognized as the boundary is present. In such a case, the HMD 100 performs processing for connecting ends of the recognized boundary with a straight line or processing for, for example, estimating the closed region from the shape of the registered object, decides the object region, and resultantly decides the background region as well. It goes without saying that, when processing for comparing brightness of pixels with a threshold with respect to a captured image and binarizing the brightness and detecting a boundary is performed, another method for, for example, sequentially changing the magnitude of the threshold, recognizing a plurality of boundaries, combining the boundaries, and deciding the object region and the background region may be used.

Subsequently, the HMD 100 selects on which of the object region and the background region processing for relatively reducing the visibility of the background of the object is performed (step S255). This is because, since easiness of visual recognition is relative, both of an increase of the visibility of the object and a reduction of the visibility of the background are the processing for relatively reducing the visibility of the background of the object. The user may operate the operation section 79 to thereby perform this selection every time when needed. The control device 70 may perform the selection and the setting in advance and refer to the setting.

When determining in step S255 that the background image is set as the target, in step S265, the HMD 100 performs processing for blurring the background image. The processing is processing for setting the brightness of the image of the background region to 50% as explained in the first embodiment. On the other hand, when determining that the object region is set as the target, in step S275, the HMD 100 performs processing for emphasizing the target object. The processing in steps S265 and S275 is collectively explained below.

After performing the processing for blurring the background image or the processing for emphasizing the target image, subsequently, the HMD 100 performs processing for inputting a signal from the six-axis sensor 66 (step S280). The signal from the six-axis sensor 66 is input in order to learn a movement of the user's head, that is, a state of a change of a visual field viewed from the HMD 100 by the user. The HMD 100 performs processing for tracing an object position from the input signal from the six-axis sensor 66 (step S285). That is, since the position in the visual field of the object found from the imaged outside scene changes according to the movement of the user's head, the position is traced. Then, the HMD 100 performs processing for displaying an image corresponding to the traced position of the object (step S295).

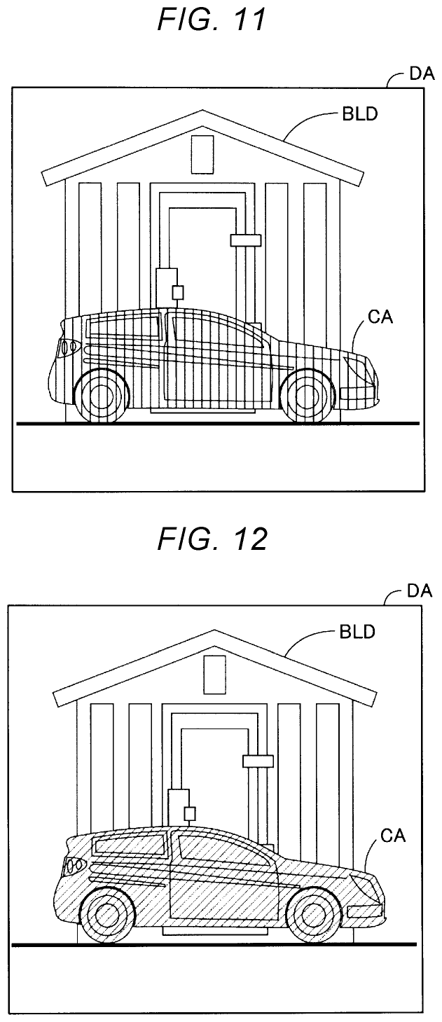

The processing for blurring the background image and emphasizing the target image in steps S265 and S275 is explained. FIGS. 11 and 12 are explanatory diagrams illustrating a case in which the target image is emphasized. FIG. 11 illustrates an image DA captured by the cameras 61R and 61L when a vehicle CA is traveling in front of a building BLD. In FIG. 11, it is assumed that hues (tints and brightness) of the building BLD and the vehicle CA are similar and the building BLD and the vehicle CA are less easily distinguished. In such a case, an image obtained by changing a color and brightness of an image of the target (the vehicle CA) to be emphasized is generated and superimposed and displayed on an object included in an outside scene in the visual field of the user. Since the position of the object is traced using the six-axis sensor 66, even if the object is moving or the user changes the position and the angle of the head, the target image can be superimposed and displayed on the object. FIG. 12 illustrates a state in which an image of a vehicle, a tint and brightness of which are changed, is superimposed and displayed on the vehicle CA in front of the building BLD. The vehicle CA, to which attention of the user is about to be brought, is displayed in a form clearly distinguished from the building BLD, that is, a state in which the visibility of the background of the object is relatively reduced. When the tint is changed, the tint may be changed to a tint known in advance as a combination colors conspicuous with respect to the background, for example, the tint may be changed to a tint having a complementary color relation with the background or, when the background is blackish, the vehicle may be changed to yellow. When the brightness is changed, the brightness of the target image may be increased and the target image may be superimposed and displayed on the target in the outside scene when the background has predetermined brightness or less, that is, the background is dark. When the background has brightness higher than the predetermined brightness, that is, the background is bright, the brightness of the target image may be reduced and the target image may be superimposed and displayed on the target in the outside scene. In both the cases, a brightness difference between the target and the background is conspicuous. The visibility of the specified object is increased with respect to the background.

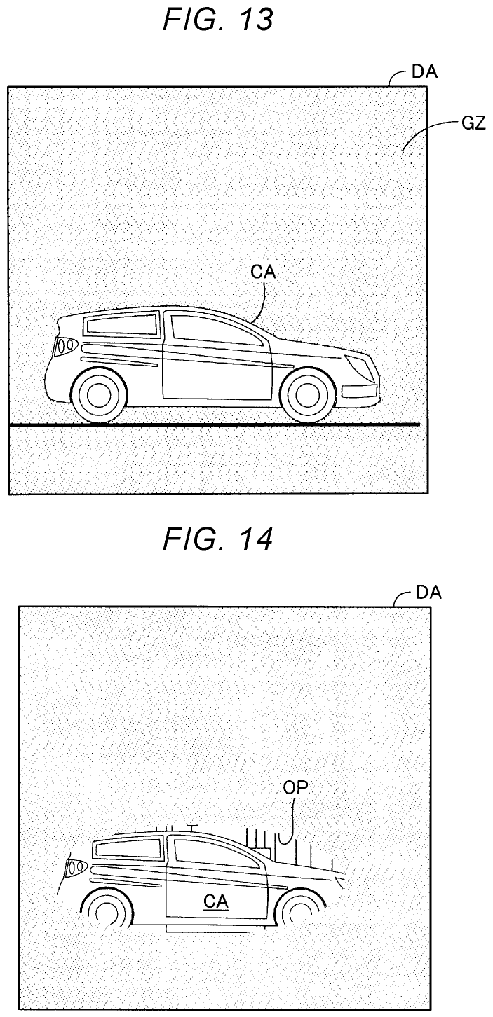

On the other hand, when the visibility of the background is relatively reduced, as explained in the first embodiment, the outside scene may be blurred or, as illustrated in FIG. 13, all parts other than the vehicle CA, which is the specified object, may be painted out with a dark color image. In this case, all dots equivalent to the background region may be colored in a specific color such as blue. In this case, since the vehicle CA, which is the specified object, is seen as it is, the user can easily visually recognize the vehicle CA. In such display in which the parts other than the object are painted out, in this embodiment, the boundary is detected and the display is clearly differentiated between the inside and the outside of the boundary of the object. However, as illustrated in FIG. 14, it is not always necessary to clearly differentiate the display in the boundary of the object. In FIG. 14, a display boundary OP is formed in an elliptical shape approximate to the shape of the object. On the inner side of the display boundary OP, the outside scene can be visually recognized as it is and the outer side of the display boundary OP is painted out. It goes without saying that the shape of the display boundary OP may be any shape. That is, the shape of the display boundary OP may be a shape including only the region on the inner side of the target object. The display boundary OP may be a region including a part on the inner side of the target object and a part on the outer side of the target object continuous to the part of the inner side (FIG. 14 is a form of such a case) or may be a region including the entire region of the target object and a part on the outer side of the target object continuous to the region of the target object. In FIGS. 13 and 14, the background is painted out. However, the outside scene may be seen at a fixed rate and blurred. The imaged outside scene may be formed as an image blurred by filter processing or the like to be superimposed and displayed on the outside scene.

In this embodiment, since the boundary is detected, the boundary may be highlighted. As highlighting of an edge, for example, a thick boundary line may be superimposed and displayed along the boundary or a boundary line may be displayed as a broken line in the boundary and a line portion of the broken line and a portion between the line and the line may be alternately displayed. The latter display is a form of display in which the portion of the line and the portion between the line and the line are alternately flashed. There is an effect of increasing the visibility of the target object. It goes without saying that the boundary line may be displayed as a solid line and the solid line may be flashed.

### C. Other Embodiments

(1) Embodiments other than the several embodiments explained above are explained. As another embodiment, there is provided a display device including a display region in a visual field of a user capable of visually recognizing an outside scene. The display device includes: a target-object specifying section configured to specify a preregistered target object together with a position in the visual field of the user; and a display control section configured to perform, as display in the display region, display of a form in which visibility of a background of the target object is reduced relatively to the specified target object. Consequently, since the background of the preregistered target object is displayed in the form in which the visibility is relatively reduced than the target object, it is possible to cause the user to easily gaze or visually recognize the preregistered target object.

(2) In the display device, the display control section may superimpose, on the background, visibility reduced display, which is the display of the form in which the visibility of the background is reduced than the target object. Consequently, since the background of the preregistered target object is displayed in the form in which the visibility is relatively reduced than the target object, it is possible to cause the user to easily gaze or visually recognize the preregistered target object.

(3) In the display device, the display control section may perform, as the visibility reduced display, display of at least one of (A) a form in which the background is blurred, (B) a form in which brightness of the background is reduced, and (C) a form in which the background is pained out in a predetermined form. Consequently, since the reduction of the visibility is relative, the visibility of the background may be realized by the visibility reduction display in which the visibility of the background is reduced.

(4) In the display device, the display control section may superimpose, on the target object, visibility increased display, which is display of a form in which visibility of the target object is increased than the background. Consequently, since the increase of the visibility is relative, it is possible to increase the visibility of the target object than the background with the visibility increased display in which the visibility of the target object is increased.

(5) In the display device, the display control section may perform, as the visibility increased display, display of at least one of (A) a form in which an edge of the target object is highlighted, (B) a form in which brightness of the target object is increased, and (C) a form in which a tint of the target object is changed. Consequently, the visibility increased display can be easily realized. Which of the methods is used only has to be determined according to a size of the target object, original easiness of the visibility of the target object, a degree of the visibility of the background, and the like.

(6) In such a display device, the display control section may divide the target object and the background by detecting a boundary of the target object and perform the display. Consequently, it is possible to clearly divide the target object and the background and easily realize display in which the visibility of the background is reduced relatively to the target object.

(7) In the display device, the display control section may set, as the background, a region other than a region including at least a part of an inner side of the target object and perform the display. Consequently, it is unnecessary to strictly divide the target object and the background. It is possible to easily change the visibility.

(8) In the display device, the region including at least a part of the inner side of the target object may be any one of [1] a region on the inner side of the target object, [2] a region including a part of the inner side of the target object and a part of an outer side of the target object continuous to the part of the inner side, and [3] a region including the entire region of the target object and a part of the outer side of the target object continuous to the region of the target object. Consequently, it is possible to flexibly determine a region of the target object where visibility is resultantly relatively increased with respect to the background.

(9) The display device may be a head-mounted display device, and the target-object specifying section may include: an imaging section configured to perform imaging in a visual field of the user; and an extracting section configured to extract the preregistered target object from an image captured by the imaging section. Consequently, even if the visual field of the user changes according to a movement of the user's head, it is possible to specify the position of the target object according to the change and easily perform, as the display in the display region, display of a form in which the visibility of the background of the target object is reduced relatively to the specified target object. It goes without saying that the display device does not need to be limited to the head-mounted type. For example, a user located in a position where a site can be monitored in a bird's eye-view manner only has to set a see-through display panel in front of the user and overlook the site via the display panel. Even in this case, when it is desired to guide the visual line of the user to a target such as a specific participant, an image for relatively reducing the visibility of the background of the target only has to be displayed on the display panel.

(10) As another embodiment, there is provided a display method for performing display in a display region in a visual field of a user capable of visually recognizing an outside scene. The display method includes: specifying a preregistered target object together with a position in the visual field of the user; and performing, as display in the display region, display of a form in which visibility of a background of the target object is reduced relatively to the specified target object. Consequently, since the background of the preregistered target object is displayed in the form in which the visibility is relatively reduced than the target object, it is possible to cause the user to easily gaze or visually recognize the preregistered target object.

(11) In the embodiments, a part of the components realized by hardware circuits may be replaced with software implemented on a processor. At least apart of the components realized by software can also be realized by discrete circuit components. In some embodiments, a processor may be or include a hardware circuit component. When a part or all of the functions of the present disclosure are realized by software, the software (a computer program) can be provided in a form stored in a computer-readable recording medium. The “computer-readable recording medium” is not limited to a portable recording medium such as a flexible disk or a CD-ROM and includes various internal storage devices in a computer such as a RAM and a ROM and external storage devices fixed to the computer such as a hard disk. That is, the “computer-readable recording medium” has a broad meaning including any recording medium that can record a data packet not temporarily but fixedly.

(12) The present disclosure is not limited to the embodiments explained above and can be realized in various configurations without departing from the gist of the present disclosure. For example, the technical features in the embodiments corresponding to the technical features in the aspects described in the summary can be substituted or combined as appropriate in order to solve a part or all of the problems described above or achieve a part of all of the effects described above. Unless the technical features are explained as essential technical features in this specification, the technical features can be deleted as appropriate. For example, the processing for highlighting the boundary of the specified object and relatively increasing the visibility of the object and the processing for relatively reducing the visibility, for example, blurring the outer side of the boundary, that is, the background may be simultaneously performed.

What is claimed is:

1. A display device including a display region that allows a scene to be perceived by a user through the display region, the display device comprising:
one or more processors configured to
specify a preregistered target object in the scene together with a position of the target object; and
perform, as display in the display region, display of a form in which visibility of a background of the target object is reduced relatively to the specified target object.

2. The display device according to claim 1, wherein the one or more processors are further configured to superimpose, on the background, visibility reduced display, which is the display of the form in which the visibility of the background is reduced than the target object.

3. The display device according to claim 2, wherein the one or more processors are further configured to perform, as the visibility reduced display, display of at least one of (A) a form in which the background is blurred, (B) a form in which brightness of the background is reduced, and (C) a form in which the background is pained out in a predetermined form.

4. The display device according to claim 1, wherein the one or more processors are further configured to superimpose, on the target object, visibility increased display, which is display of a form in which visibility of the target object is increased than the background.

5. The display device according to claim 4, wherein the one or more processors are further configured to perform, as the visibility increased display, display of at least one of (A) a form in which an edge of the target object is highlighted, (B) a form in which brightness of the target object is increased, and (C) a form in which a tint of the target object is changed.

6. The display device according to claim 1, wherein the one or more processors are further configured to divide the target object and the background by detecting a boundary of the target object and performs the display.

7. The display device according to claim 1, wherein the one or more processors are further configured to set, as the background, a region other than a region including at least a part of an inner side of the target object and performs the display.

8. The display device according to claim 7, wherein the region including at least a part of the inner side of the target object is any one of [1] a region on the inner side of the target object, [2] a region including a part of the inner side of the target object and a part of an outer side of the target object continuous to the part of the inner side, and [3] a region including the entire region of the target object and a part of the outer side of the target object continuous to the region of the target object.

9. The display device according to claim 1,
comprising a camera to capture a scene including the target object and the background,
wherein the display device is a head-mounted display device, and
the one or more processors are further configured to extract the preregistered target object from the image captured by the camera.

10. A display method for performing display in a display region while allowing a scene to be perceived by a user through the display region, the display method comprising:
specifying a preregistered target object in the scene together with a position of the target object; and
performing, as display in the display region, display of a form in which visibility of a background of the target object is reduced relatively to the specified target object.
